(19) United States
(12) Patent Application Publication
(10) Pub. No.: US 2018/0028384 A1
(43) Pub. Date: Feb. 1, 2018

(54) Quarter turn track bracket (QTTB) for patient lifter ceiling track mechanism and methods thereof

(71) Applicant: Savaria Concord Lifts Inc., Brampton (CA)

(72) Inventors: Jonathan BENOIT, Sherbrooke (CA); Christian DEGRACE, Magog (CA); Michel CORRIVEAU, Saint-Denis-de-Brompton (CA); Nicholas KENT, Farnham (GB)

(21) Appl. No.: 15/666,369

(22) Filed: Aug. 1, 2017

Related U.S. Application Data
(60) Provisional application No. 62/369,407, filed on Aug. 1, 2016.

(51) Int. Cl. A61G 7/10; B66F 9/00

(52) U.S. Cl. CPC A61G 7/1073; A61G 7/1013; B66F 9/00

(57) ABSTRACT

It is often required in the medical industry to have devices, such as patient lifters, anchored to the ceiling. A system and method have been developed to resolve various challenges posed by installation of ceiling tracks intended to be used with patient lifters. The QTTB allows gaining in installation speed while increasing its inherent safety by the reduction of component hence the reduction of required human operations and verifications. The system comprises a bracket for supporting the track and a load, the bracket comprising a T-shaped member; and an attachment member affixed to the ceiling and adapted for receiving the bracket; the T-shaped member being adapted to rotate within the track from a first position to a second position, wherein, in the second position, the track is substantially unable to move along an axis of the attachment member. A tool may be used to rotate the bracket.

### CROSS-REFERENCE TO RELATED APPLICATIONS

The present patent application claims the benefits of priority of U.S. Provisional Patent Application No. 62/369,407, entitled “Quarter turn track bracket (QTTB) for patient lifter ceiling track mechanism and methods thereof”, and filed at the United States Patent and Trademark Office on Aug. 14, 2016, the content of which is incorporated herein by reference.

### FIELD OF THE INVENTION

The present invention generally relates to the field of patient lifting devices and more specifically to the ceiling track bracket used to support the track system.

### BACKGROUND OF THE INVENTION

The quarter turn track bracket (QTTB) system has been developed to resolve various challenges posed by installation of ceiling tracks intended to be used with patient lifters. The QTTB allows gaining in installation speed while increasing its inherent safety by the reduction of component hence the reduction of required human operations and verifications.

Prior art in relation with the present invention includes known designs of support bracket and hardware commonly found in various industrial fixation systems. Such mechanism use the quarter turn motion to lock and unlock the hardware to the track and usually a manual operation to secure the installation such as torque applied, use of jam nut, and the likes.

Obviously, such prior art mechanism or other prior art devices are non compliant with the medical equipment regulations. Additionally, such systems do not have the required minimal production and quality controls or all the risk management requirements. As a result, there is a need for a novel medical track bracket system meeting the requirements of the actual medical industry.

### SUMMARY OF THE INVENTION

The QTTB allows gaining in installation speed while increasing its inherent safety by the reduction of hardware components needed to affix the bracket and the associated track. The intuitive locking motion and its auto-blocking feature further reduce the safety of the bracket by the reduction of operations and verifications that have to be performed by humans throughout the whole lifecycle of the system.

The invention is directed to a system to securely attach a track to a surface, the system comprises a bracket assembly pivotally attached to the surface. The bracket assembly comprises a bracket portion adapted to slidingly hold the track and a resilient member between the bracket portion and the surface. The system further comprises the track comprising a top opening. The bracket assembly being adapted to be rotated in a unlocked position and a locked position when slid into the track. The resilient member being outside the top opening of the track when in the unlocked position. The resilient member being biased within the top opening of the track when in the locked position.

In one aspect of the invention, the resilient member being protruding tabs, the bracket assembly being adapted to be rotated using a tool and the tool comprising fingers adapted to be inserted under the resilient member and on each side of the bracket assembly. The tool may further be adapted to bias the resilient member. The resilient member being shaped to receive the fingers of the tool.

In another aspect of the invention, the system further comprises an attachment member affixed to the surface and adapted for receiving the bracket. The attachment member may be a rod.

In yet another aspect of the invention, the bracket assembly further comprises a central aperture adapted to pivotally receive the rod.

In yet another aspect of the invention the bracket assembly further comprises a central portion between the resilient member and the bracket portion, the central portion being thinner than the resilient member and the bracket portion. The track further comprises tab portion on each side of the top opening, the central portion being adapted to slidingly receive tab portions.

In another aspect of the invention, the bracket assembly further comprises a finishing plate between the bracket assembly and the surface. The finishing plate comprising an outer surface made of low friction material.

In another aspect of the invention, the invention is directed to a system to securely attach a track to a surface, the system further comprising:
a bracket for supporting the track and a load, the bracket comprising a T-shaped member; and
an attachment member affixed to the surface and adapted for receiving the bracket;
the T-shaped member being adapted to rotate within the track from a first position to a second position, wherein, in the second position, the track is substantially unable to move along an axis of the attachment member.

The bracket may further comprise protruding tabs such that, when the bracket is in the second position, rotation of the bracket is substantially blocked.

In a preferred embodiment, the rotation of the T-shaped member may be achieved with a tool adapted to ease the rotation of the bracket assembly during the track installation and to allow the unlocking of bracket therefore allowing rotation of the bracket for its uninstallation.

The present invention is further directed to a method for securely attaching a track to a surface, the method comprises the steps of rotatably attaching a bracket assembly to the surface, the bracket assembly comprises a bracket portion adapted and a resilient member between the bracket portion and the surface; slidingly inserting the track in the bracket assembly and rotating the bracket from a first position to a second position, wherein in the second position, the resilient member limits the movement of the track with regard to the bracket assembly.

In one aspect of the invention, the surface further comprises an attachment member, wherein the step to rotatably attach the bracket assembly to the surface further comprises pivotally mounting the bracket assembly to the attachment member.

In another aspect of the invention, the attachment member is a rod and the bracket assembly comprises an aperture, the method further comprises sliding the rod within the aperture of the bracket assembly. The bracket is rotated from the second position to the first position.

In yet another aspect of the invention, the step to rotate the bracket from a first position to a second position further comprises using a tool adapted to rotate the bracket assembly from the first position to the second position.

In yet another aspect of the invention, the method further comprises using the tool to upwardly bias the resilient portion to allow rotation of the bracket assembly. The rotation from the first position to the second position is about 90 or 270 degrees.

The invention is further directed to a method for securely installing a track to a surface, the surface comprising an attachment member, the method comprising the steps of:
inserting a bracket within the track, the bracket being pivotally mounted on the attachment member; and
rotating the bracket from a first position to a second position, wherein, in the second position, movement of the track following a direction normal to the surface is substantially limited.

The method may further comprise the steps of:
mounting the bracket to the attachment member; and
blocking any unexpected rotation of the bracket when the track is attached to the bracket.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawing below in which:

FIG. 1 is an exploded perspective view of the system in accordance with the principles of the present invention.

FIG. 2 is an exploded perspective view of the track bracket system in accordance with the principles of the present invention.

FIG. 3 is an exploded perspective view of the track bracket mechanism in accordance with the principles of the present invention

FIG. 4 is an assembled side view of the bracket mechanism installed to a ceiling structure.

FIG. 5 is an assembled side view of a track attached to the bracket mechanism installed to a ceiling structure and locked in place.

FIGS. 6A-D are perspective views of the operation steps to lock the bracket assembly in place by the mean of the adapted tool.

### DETAILED DESCRIPTION OF THE PREFERRED EMBODIMENT

A novel QTTB will be described hereinafter. Although the invention is described in terms of specific illustrative embodiments, it is to be understood that the embodiments described herein are by way of example only and that the scope of the invention is not intended to be limited thereby.

The invention is intended to be used with ceiling patient lifter track systems wherein the need of fast and simple installation with low complexity installation and maintenance levels are required.

The present invention generally relates to the field of patient lifting devices and more specifically to the ceiling track bracket used to support the track system.

The quarter turn track bracket (QTTB) system 100 has been developed to resolve various challenges posed by installation of ceiling tracks intended to be used with patient lifters. The QTTB allows gaining in installation process speed while increasing its inherent safety by the reduction of components hence the reduction of required human operations and verifications.

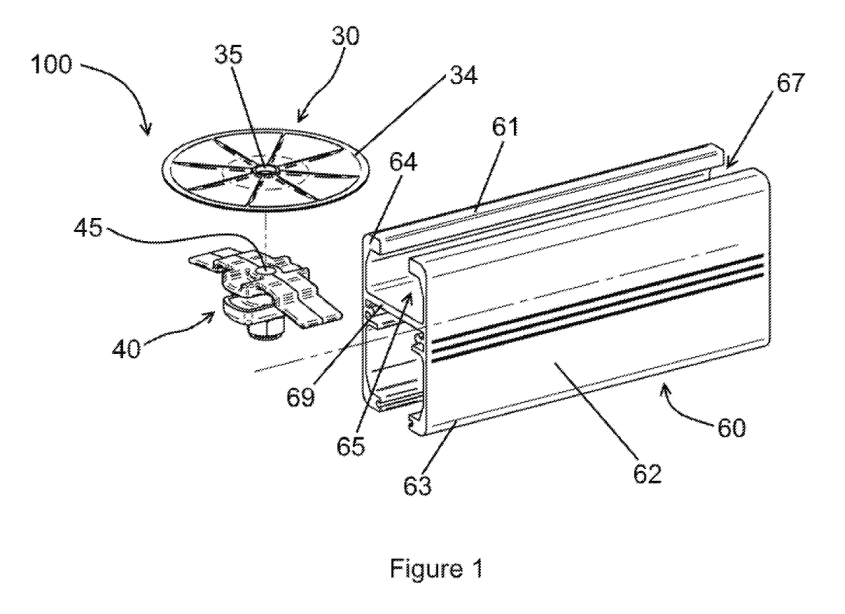

Now Referring to FIG. 1, an exemplary QTTB and track system 60 are illustrated. The track 60 typically supports a patient lifter (not shown) or any other system allowing a patient to be attached, lifted and moved along the track. Understandably, any other track known in the art may be used without departing from the scope of the present invention.

Still referring to FIG. 1, in the present embodiment, the track system 60 typically comprises two sides 62, a top portion 61 and a bottom portion 63. The top portion 61 comprises an opening 67 and is generally shaped to comprise tabs 64. In a preferred embodiment, the track system 60 further comprises a separating member 69, the separating portion 69, the sides 62 and the top portion 51 forming a hollow portion 65.

The system further comprises a bracket 40. The bracket 40 is preferably pivotally connected to the ceiling 10 or to a structure behind the ceiling 10. The bracket 40 is adapted to support the track 60. In some embodiment, the bracket 40 is attached to the surface 10 or to a structure being the surface 10 along an axis being substantially perpendicular to the surface 10. It shall be understood by one skilled in the art that any mean of attaching the bracket 40 to the surface 10 may be used without departing from the principles of the present invention.

An embodiment of a bracket system using a finishing ceiling plate 3 is shown but any other mean known in the art to provide an anchoring to a ceiling or any other surface may be used.

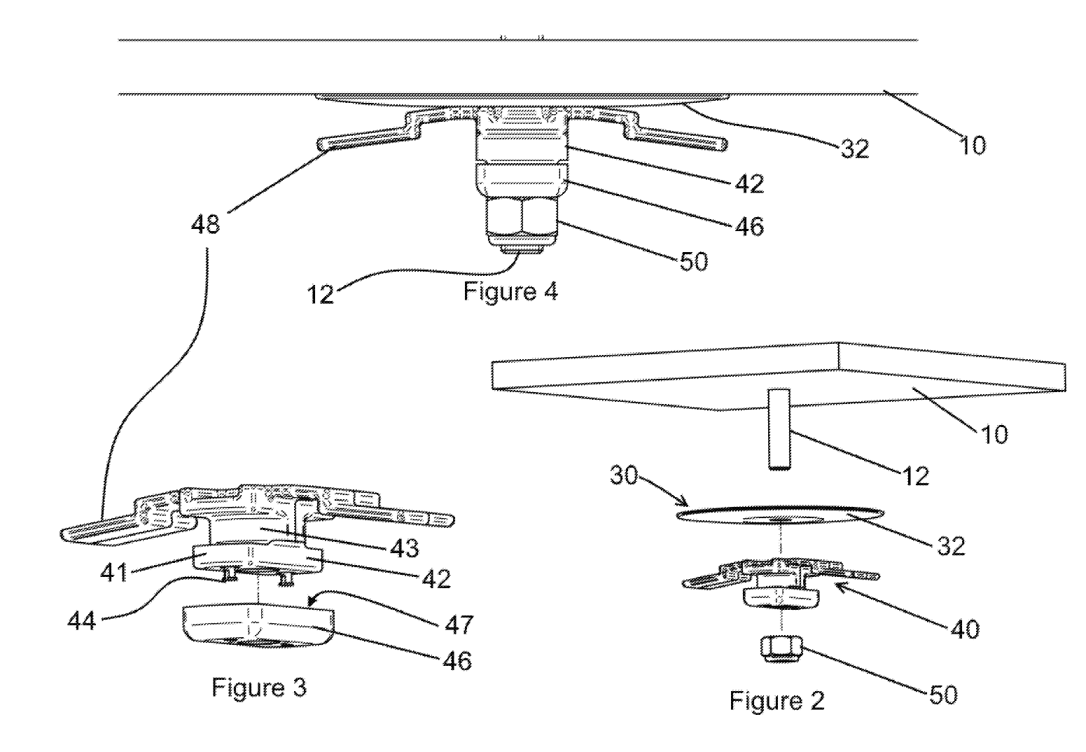

Now referring to FIGS. 1 and 2, the system 100 may comprise an attachment member 12 affixed or attached to the ceiling structure 10. The attachment member 12 is preferably adapted to pivotally receive the bracket 40 along a substantially vertical axis. The vertical axis is preferably substantially perpendicular to the ceiling structure. In a preferred embodiment, the attachment member 12 may be, but not limited to, a threaded rod connected to a structural anchor (not shown). Understandably, any other mean known in the art to anchor or attach the bracket 40 to a ceiling 10 or any other surface may be used without departing from the scope of the present invention.

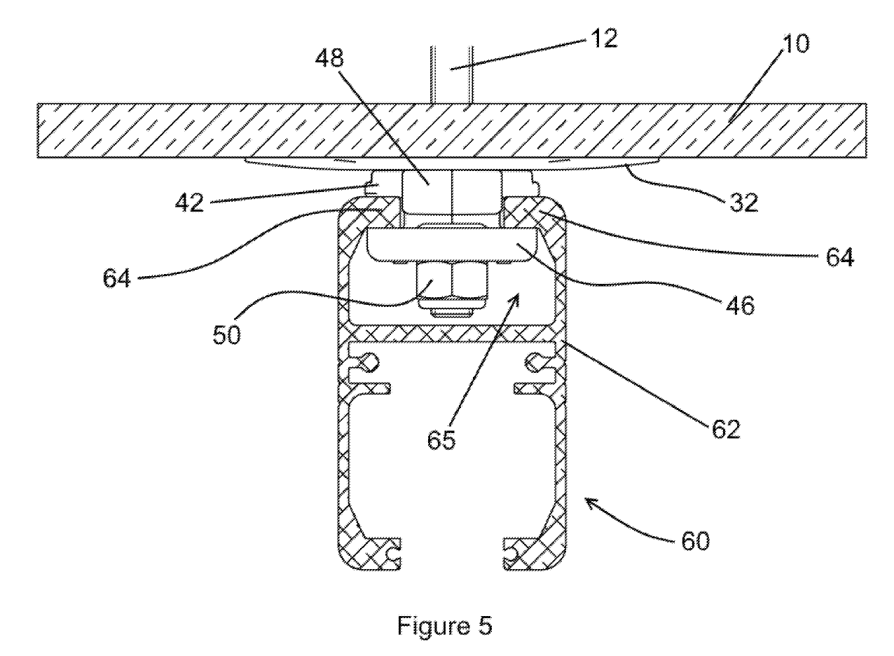

Now referring to FIG. 5, the bracket assembly 40 is pivotally attached to the attachment member 12. The attachment member 12 is adapted to limit the movement of the bracket assembly 40 along the longitudinal axis of the attachment member 12. In a preferred embodiment, a locking element 50, such as a locking nut, may be used to limit movement of the bracket assembly 40. Understandably, any other mean know in the art may be used to maintain the bracket assembly 40 on the attachment member 12.

Now referring to FIG. 3, an exemplary bracket assembly 40 is illustrated. The bracket 40 comprises a rigid bracket 46 and a generally resilient member 42. The rigid bracket or bracket portion 46 is typically made of metal or material adapted to support the lifting device and the lifted load. The rigid bracket 46 is rigidly attached to the resilient member 42. In a preferred embodiment, the rigid bracket 46 is attached to the resilient member 42 using molded clips 44. It shall be understood by a person in the art that screws, rivet or the likes may be used to affix the rigid bracket 46 to the resilient member 42. In other embodiments, the resilient member 42 and the rigid bracket 46 may be unitary.

In a preferred embodiment, the resilient member 42 comprises a substantially T-shaped resilient top portion 48, a central or neck portion 43 and a bottom portion 41. The bottom portion 41 is shaped to be retained by the tabs 64 of the track assembly 61 when turned in one direction and to fit within the aperture 67 when turned in another direction. Preferably, the angle between the two directions is about 90 degrees or 270 degrees.

In a preferred embodiment, the top portion 48 of the bracket 40 comprises protruding members substantially shaped as wings. The said wings are preferably made of resilient material.

The geometry of the T-shaped member 42 is preferably adapted to mate with inner surface 47 of the rigid bracket 46 to transmit the torque required to turn the bracket assembly 40 in place during the installation of the track 60.

Referring back to FIG. 1, the bracket assembly 40 preferably comprises a central aperture or passage 45 adapted to receive the attachment member 12 and to allow rotational movement of the bracket 40 with regards to the attachment member 12. In a preferred embodiment, the aperture or passage 45 may be threaded.

In some embodiments, the system 100 comprises a finishing ceiling plate 30. The finishing ceiling plate 30 is adapted to be inserted between the ceiling 10 and the bracket 40. In a preferred embodiment, the finishing ceiling plate 30 comprises an outer surface 32 and an inner surface 34. The outer surface 32 is adapted to provide a low friction surface for the bracket 40 to rotate. The outer surface 32 is preferably made of low friction material. The outer surface 32 aims at providing an aesthetic connection between the bracket 40 and the ceiling 30.

Referring now to FIG. 4, the bracket assembly 40 is shown installed to a ceiling structure 10. The finishing plate 30 is inserted between the ceiling 10 and the T-shaped member 42 of the bracket assembly 40. The bracket 40 is shown in rotated in first position, the first position allowing the bracket 40 to be inserted or be received by the track 60.

Referring now to FIG. 5, a bracket assembly 40 installed to the ceiling structure 10 and locked in place to the track 6 is shown. In such an embodiment, the bracket assembly 40 is pivotally mounted on the attachment member 12, or rod, and maintained in place using a mounting element or device 50, preferably a locking nut. The bracket 4—is shown in a second position. In such a second position, the track 60 is locked to the bracket 40.

Still referring to FIG. 5, in a preferred embodiment, the bracket portion 46 has a substantially rectangular shape. In such an exemplary embodiment, the shortest side of the bracket portion 46 is thinner than the opening 67 of the top portion 61 of the track 60 to allow the bracket 46 to be inserted in the hollow portion 65 of the track 60. The longest side is preferably wider than the opening 65 to limit or block retraction of the T-shaped member 42 from the track 60. Accordingly, the hollow portion 65 a wider than the opening 67 of the track 50. The opening 67 is preferably formed with tabs 64 of the upper portion 61 of the track 60 to support the load transferred from the track 60 to the bracket assembly 40 and to the attachment member 12.

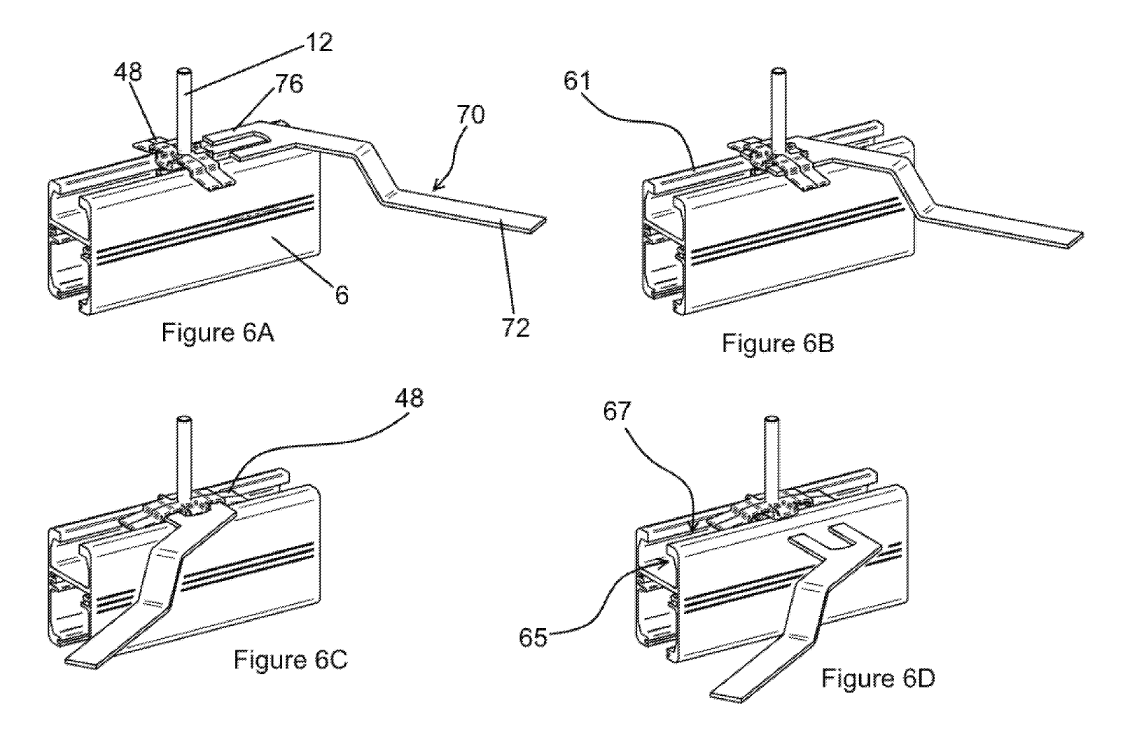

Now referring to FIGS. 6A to 6D, a method for installing and locking a QTTB system is shown. The method generally provides steps to lock the bracket assembly 40 to the track 60, preferably using an adapted tool 70.

The method of locking the QTTB to the track 60 comprises the step of pivotally attaching the bracket 40 to the ceiling 10 or other surface. In a preferred embodiment, the bracket 40 is pivotally attached to the attachment member 12. The method further comprises inserting the track 60 around the bracket 40. In a preferred embodiment, the bracket portion 46 is inserted in the hollow portion 65 of the track 60. The neck portion 43 is preferably positioned between the tabs 64 of the top portion 61 of the track assembly 60. The top portion 48 of the T-shaped member 42 is positioned to be substantially perpendicular to the length of the track 60. In a preferred embodiment, the protruding portions of the top portion 48 are extending over each side 62 of the track assembly 60 (for instance, see FIG. 6A). In other words, the protruding members are visible from the ground when the bracket 40 is in the unlocked position. In such a position, the track 60 is now supported by the bracket 40 but the track 60 may still slide with regard to the bracket 40.

Referring now to FIG. 6B, the method further may comprise inserting an adapted tool 70 between the T-shaped member 42 of the bracket assembly 40 and a top portion 61 of the track assembly 60. Upon insertion of the tool 70, the tool 70 is rotated about 90 degrees, such rotation triggering the rotation of the T-shaped member 42 in the same direction. As shown in FIG. 6C, such rotation causes the protruding tabs 48 to move from a substantially perpendicular position with regard to the track 60 to a substantially parallel position to the track 60. Understandably, the rotation may be clockwise or counter-clockwise.

Now referring to FIG. 6C, the bracket 40 is shown after being rotated by a clockwise quarter turn. In such position, the bracket assembly 40 supports the track 60 and any load to be applied on the track 60. Consequently, the protruding tabs 48 of the bracket assembly 40 are not visible from the ground. In a preferred embodiment, the protruding tabs 48 are made with resilient material. Upon being rotated, the protruding tabs 48 move within the top opening 67 of the track 60 toward the hollow portion 65. In such a position, the rotational movement of the QTTB system 100 is stopped or at least substantially limited. Such movement is limited or stopped by the friction between the bottom portion of the top portion 48 of the T-shaped member 42 and the top portion 61 of the track 60.

Now referring to FIG. 6D, the method may further comprise removing the tool 70 from the bracket assembly 40 after installing the said bracket assembly 40. In a preferred embodiment and as explained above, the protruding tabs 48 are made of resilient material. This characteristic allows the protruding tabs 48 to be further downwardly pushed within the opening 67 and toward the hollow portion 65 of the track 60. The protruding tabs 48 are preferably surrounded by the tabs 64, acting as a locking mechanism to block or substantially limit any rotational movement of the bracket assembly 40 with regard to the track 60. Accordingly, the width of the protruding tabs 48 is preferably less than the width of the opening 67 of the track 60.

The method may further comprise inserting the adapted tool 70 into the installed bracket 40. The insertion of the adapted tool 70 raises both resilient protruding tabs 48 above the track surface thereby allowing the rotation of the bracket assembly 40 with regards to the track 60 for uninstallation purposes or for sliding the tracking with regard to the bracket 40.

Referring to FIG. 6A, the system 100 may further comprises a tool 70 adapted to rotate the bracket 40. The tool 70 comprises a mechanism 76 to surround the bracket 40. In a preferred embodiment, the mechanism 76 comprises fingers adapted to be inserted between the resilient member 48 and the top portion 61 of the track 70. The tool 70 is further adapted to upwardly bias the resilient member 48 to allow rotation of the bracket 40 about the track 70. Upon removal of the tool 70, the resilient member 48 downwardly bias against the top portion of the track (for uninstallation) or toward the hollow portion 65 within the top opening 67 of the track 70.

In other embodiments, a plurality of bracket assemblies 40 may be attached to the ceiling to attach a track 60 to the ceiling 10. The number of required bracket assemblies 40 generally depends on factors such as the length or shape of the track and/or on the desired load to be supported by the track. In a preferred embodiment, the bracket assemblies 40 are aligned in order to easily slide the track 60 within the aligned bracket assemblies 40.

In such embodiments, the method to lock and/or unlocked the bracket assembly 40 must be repeated for each bracket assembly 40 to allow sliding the track 60 about the bracket assembly 40.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A system to securely attach a track to a surface, the system comprising:
a bracket assembly pivotally attached to the surface, the bracket assembly comprising:
a bracket portion adapted to slidingly hold the track;
a resilient member between the bracket portion and the surface;
the track comprising a top opening;
the bracket assembly being adapted to be rotated in a unlocked position and a locked position when slid into the track;
the resilient member being outside the top opening of the track when in the unlocked position;
the resilient member being biased within the top opening of the track when in the locked position.

2) The system of claim 1, the resilient member being protruding tabs.

3) The system of claim 1, the bracket assembly being adapted to be rotated using a tool.

4) The system of claim 3, the tool being adapted to bias the resilient member.

5) The system of claim 4, the tool comprising fingers adapted to be inserted under the resilient member and on each side of the bracket assembly.

6) The system of claim 5, the resilient member being shaped to receive the fingers of the tool.

7) The system of claim 1, the system further comprising an attachment member affixed to the surface and adapted for receiving the bracket.

8) The system of claim 7, the attachment member being a rod.

9) The system of claim 8, the bracket assembly further comprising a central aperture adapted to pivotally receive the rod.

10) The system of claim 1, the bracket assembly further comprising a central portion between the resilient member and the bracket portion, the central portion being thinner than the resilient member and the bracket portion.

11) The system of claim 10, the track further comprising tab portion on each side of the top opening, the central portion being adapted to slidingly receive tab portions.

12) The system of claim 1, the bracket assembly further comprising a finishing plate between the bracket assembly and the surface.

13) The system of claim 12, the finishing plate comprising an outer surface made of low friction material.

14) A method for securely attaching a track to a surface, the method comprising the steps of:
rotatably attaching a bracket assembly to the surface, the bracket assembly comprising a bracket portion adapted and a resilient member between the bracket portion and the surface;
slidingly inserting the track in the bracket assembly;
rotating the bracket from a first position to a second position, wherein in the second position, the resilient member limits the movement of the track with regard to the bracket assembly.

15) The method of claim 14, the surface further comprising an attachment member, wherein the step to rotatably attach the bracket assembly to the surface further comprises pivotally mounting the bracket assembly to the attachment member.

16) The method of claim 15, wherein the attachment member is a rod and the bracket assembly comprising an aperture, the method further comprising sliding the rod within the aperture of the bracket assembly.

17) The method of claim 14, wherein the bracket is rotated from the second position to the first position.

18) The method of claim 14, wherein the step to rotate the bracket from a first position to a second position further comprises using a tool adapted to rotate the bracket assembly from the first position to the second position.

19) The method of claim 18, wherein the method further comprising using the tool to upwardly bias the resilient portion to allow rotation of the bracket assembly.

20) The method of claim 14, wherein the rotation from the first position to the second position is about 90 or 270 degrees.
